(19) United States
(12) Patent Application Publication
(10) Pub. No.: US 2025/0307864 A1
(43) Pub. Date: Oct. 2, 2025

(54) PROVIDING A CREDIT TO AN ACCOUNT ASSOCIATED WITH A NON-GAMING PURCHASE IN RESPONSE TO ACTIVITY WITHIN A CASINO

(71) Applicant: IGT, Las Vegas, NV (US)

(72) Inventors: Ethan EDSALL, Sparks, NV (US); Dwayne DAVIS, Reno, NV (US); Kevin HIGGINS, Reno, NV (US)

(73) Assignee: IGT, Las Vegas, NV (US)

(21) Appl. No.: 18/618,525

(22) Filed: Mar. 27, 2024

(51) Int. Cl. G06Q 30/0207; G06Q 30/0235; G07F 17/32

(52) U.S. Cl. CPC G06Q 30/0215; G06Q 30/0235; G07F 17/3239

(57) ABSTRACT

A system can include processing circuitry and memory coupled to the processing circuitry. The memory can have instructions stored therein that are executable by the processing circuitry to cause the system to perform operations. The operations can include determining that an individual made a non-gaming purchase. The operations can further include determining that a gaming-related condition has been met subsequent to the non-gaming purchase. The operations can further include applying a credit to an account associated with the individual based on determining that the gaming-related condition has been met.

### BACKGROUND

Embodiments described herein relate to operations of casinos to provide both gaming and non-gaming products/services. In some examples, a casino can include an electronic gaming machine (“EGM”) that can have one or more games (e.g., wagering games) stored therein that can be played by a player. The EGM can provide a prize to the player based on a wager and an outcome of a wagering game. In additional or alternative examples, a casino can include theatres, restaurants, hotels, and retail that provide non-gaming related products and/or services.

### SUMMARY

According to some embodiments, a system is provided. The system includes processing circuitry and memory coupled to the processing circuitry. The memory has instructions stored therein that are executable by the processing circuitry to cause the system to perform operations. The operations include receiving an identifier of a non-gaming purchase from a device. The operations further include verifying the non-gaming purchase based on the identifier of the non-gaming purchase. The operations further include, responsive to verifying the non-gaming purchase, transmitting instructions to the device to provide an award associated with the non-gaming purchase.

According to other embodiments, an electronic gaming machine (“EGM”) configured to provide a wagering game is provided. The EGM includes processing circuitry and memory coupled to the processing circuitry. The memory has instructions stored therein that are executable by the processing circuitry to cause the EGM to perform operations. The operations include receiving user input indicating an identifier of a non-gaming purchase. The operations further include verifying the non-gaming purchase based on the identifier of the non-gaming purchase. The operations further include, responsive to verifying the non-gaming purchase, providing a gaming award associated with the wagering game based on the non-gaming purchase.

According to other embodiments, a non-transitory computer readable medium is provided. The non-transitory computer readable medium has instructions stored therein that are executable by processing circuitry to cause the processing circuitry to perform operations. The operations include determining that a player has made a non-gaming purchase. The operations further include providing a gaming-related award to the player based on determining that the player has made the non-gaming purchase.

According to other embodiments, a system is provided. The system includes processing circuitry and memory coupled to the processing circuitry. The memory has instructions stored therein that are executable by the processing circuitry to cause the system to perform operations. The operations include determining that an individual made a non-gaming purchase. The operations further include determining that a gaming-related condition has been met subsequent to the non-gaming purchase. The operations further include applying a credit to an account associated with the individual based on determining that the gaming-related condition has been met.

According to other embodiments, an electronic gaming machine (“EGM”) is provided. The EGM includes processing circuitry and memory coupled to the processing circuitry. The memory has instructions stored therein that are executable by the processing circuitry to cause the EGM to perform operations. The operations include receiving user input indicating an identifier of a non-gaming purchase. The operations further include transmitting an indication of the identifier of the non-gaming purchase to a remote device. The operations further include, responsive to transmitting the indication of the identifier of the non-gaming purchase, receiving an indication of a gaming-related condition. The operations further include determining that the gaming-related condition has been met. The operations further include transmitting an indication that the gaming-related condition has been met.

According to other embodiments, a non-transitory computer readable medium is provided. The non-transitory computer readable medium has instructions stored therein that are executable by processing circuitry to cause the processing circuitry to perform operations. The operations include determining that a gaming-related condition has been met subsequent to a non-gaming purchase. The operations further include applying a credit to an account associated with the non-gaming purchase based on determining that the gaming-related condition has been met.

According to other embodiments, EGMs, systems, methods, and non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIGS. 3-5 are block diagrams illustrating examples of network configurations configured to allow casino awards based on a non-gaming purchase according to some embodiments;

FIG. 6 is a flow chart illustrating an example of operations performed by an electronic gaming machine to provide an award in response to a non-gaming purchase according to some embodiments; and

FIG. 7 is a flow chart illustrating an example of operations performed by an promotion management system to provide an award in response to a non-gaming purchase according to some embodiments.

FIG. 8 is a flow chart illustrating an example of operations performed by an electronic gaming machine to determine a condition associated with a non-gaming purchase has been met according to some embodiments; and

FIG. 9 is a flow chart illustrating an example of operations performed by an promotion management system to credit an account associated with a non-gaming purchase according to some embodiments.

### DETAILED DESCRIPTION

Casinos can attract and retain some patrons by offering wagering games (e.g., via electronic gaming machines (“EGMs”) or via table games) with the opportunity to win prizes. However, some casino patrons are less drawn to wagering games than to other casino activities (e.g., non-gaming activities such as eating, shopping, sleeping, or attending a show). Likewise, some casino patrons are less drawn to some non-gaming activities at a casino than its wagering games. As a result, some casino patrons are only drawn to a specific casino for a specific activity. This can result in a casino patron spending less time in the casino and/or spending less money in the casino.

In order to drive gaming spend on a casino floor, it can be important to engage existing customers from other areas of the casino operator's business. Various embodiments herein describe procedures for providing an incentive to a casino patron (that has previously made a non-gaming purchase) to encourage the casino patron to perform an additional gaming and/or non-gaming activity within the casino.

In some embodiments, a redemption code can be provided to a purchaser of a non-gaming purchase and the redemption code can be redeemed for an award at another activity within the casino. In some examples, a system can be provided whereby a configurable bonus of promotional funds can be awarded to casino players by way of a code printed onto a receipt issued at retail and/or service spend locations. This can be particularly useful to attract an anonymous player to the gaming floor but could also be used for casino club members or as an entry point to enroll into the player club itself. Additional use cases for receipt-based codes include entries into promotional drawings, or as the code for walk up slot tournament.

In additional or alternative embodiments, a redemption code can be provided to purchaser of a non-gaming purchase and the redemption code can be associated with a condition that when met results in a reduction in the price of the non-gaming purchase. In some examples, a system can be provided whereby an account associated with a non-gaming purchase can be credited in response to a purchaser playing a predetermined amount of a wagering game after providing a redeemable code (received in response to making the non-gaming purchase).

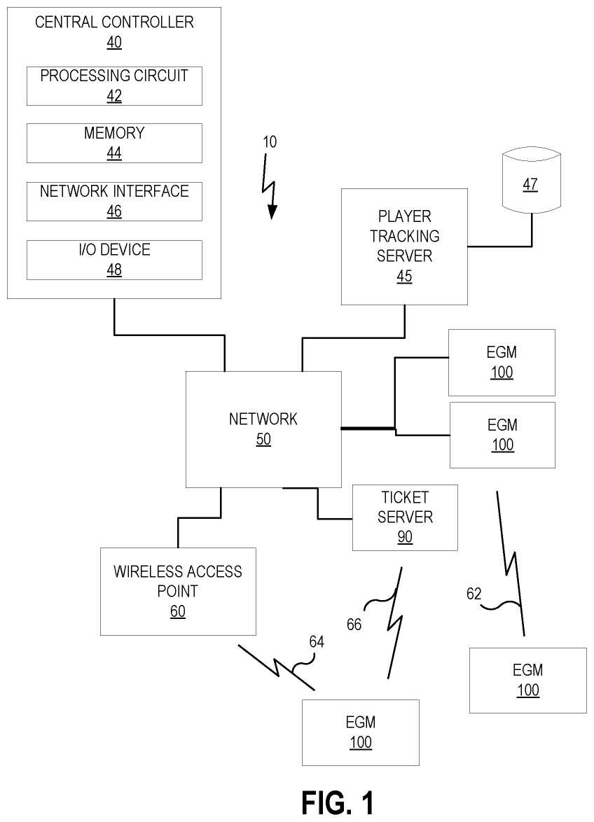

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

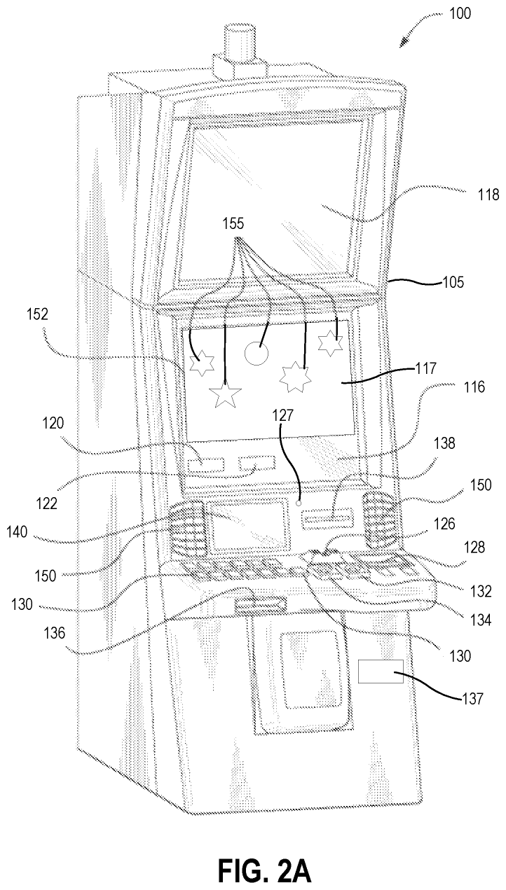

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

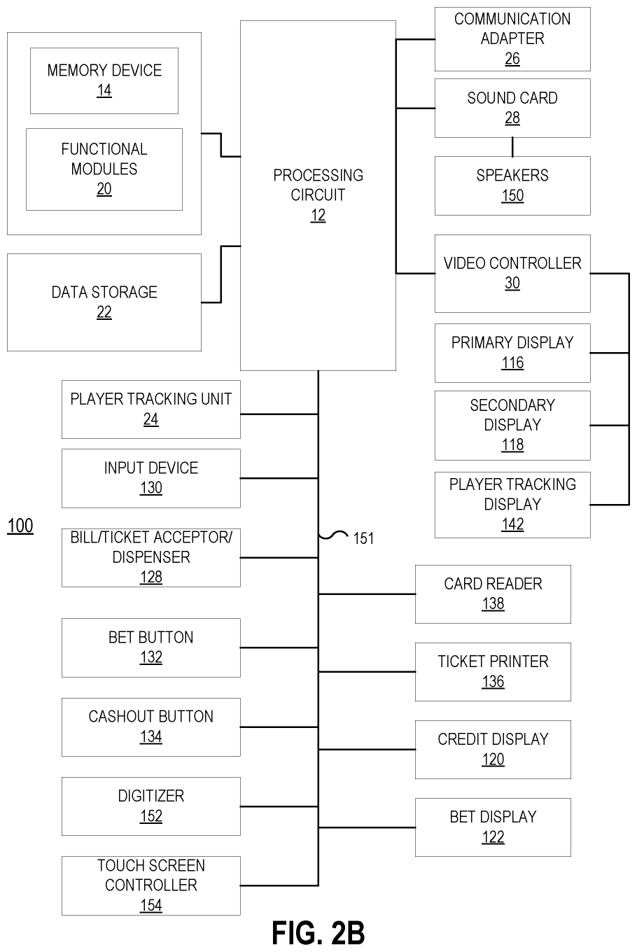

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments herein can provide a promotion to a casino patron that has made a non-gaming purchase to incentivize them to perform an activity (subsequent to the non-gaming purchase) in the casino environment.

In some embodiments, a casino patron can receive a redeemable code in response to completing the non-gaming purchase. In some examples, the redeemable code can be used to receive a gaming credit (e.g., an amount of free play or free spin) at a gaming table or an EGM. In additional or alternative examples, the redeemable code can be used to receive a non-gaming credit at a casino store (e.g., a restaurant, a store, or a hotel). The amount of the credit can be based on a value of the non-gaming purchase, an amount of time since the non-gaming purchase, and a tier level of an account associated with a player that redeems the redeemable code. The redeemable code may only be used by the customer or may be used by any player with the code.

In additional or alternative embodiments, a conditional credit can be generated in response to the casino patron completing the non-gaming purchase. In some examples, once a condition associated with the conditional credit is met, the conditional credit can be allocated to an account associated with the customer. The conditional credit may reduce the price of the non-gaming purchase. In some examples, the condition may include the customer performing a gaming or non-gaming activity within a predetermined amount of time of the non-gaming purchase. In additional or alternative examples, the condition may include the customer performing a gaming or non-gaming activity within a predetermined amount of time of a product or service associated with the non-gaming purchase being provided.

FIGS. 3-5 illustrate examples of network configurations for performing one or more of the embodiments described herein. FIG. 3 illustrates an example of a network 300 that includes a casino device 300, promotion management system 350, and point of sale system 380.

In some embodiments, a user 310 can perform a non-gaming purchase at the point of sale system 380. In some examples, the point of sale system 380 can include a retail store with a point of sale terminal and the non-gaming purchase can include purchasing a non-gaming product from the point of sale terminal. In additional or alternative examples, the point of sale system 380 can include a hotel reservation system and the non-gaming purchase can include making a hotel room reservation. In additional or alternative examples, the point of sale system 380 can include a restaurant and the non-gaming purchase can include ordering a meal at the restaurant. In additional or alternative examples, the point of sale system 380 can include a ticket provider and the non-gaming purchase can include purchase of a ticket to a casino show.

In additional or alternative embodiments, the point of sale system 380 can provide a redemption code 382 to the user 310 in response to completion of the non-gaming purchase 312. In some examples, the redemption code 382 is generated by the point of sale system 380 and an indication of the redemption code 382 is transmitted by the point of sale system 380 to the promotion management system 350. In additional or alternative examples, the redemption code 382 is generated by the promotion management system 350 and an indication of the redemption code 382 is transmitted by the promotion management system 350 to the point of sale system 380. In additional or alternative examples, the redemption code 382 is provided to the user 310 via a physical identifier (e.g., a QR code, a barcode, or an alpha-numeric code) given to the user 310 (e.g., on a receipt of the non-gaming purchase). In additional or alternative examples, the redemption code 382 is digitally provided to the user 310.

In additional or alternative embodiments, the casino device 300 receives the redemption code 382 from the user 310. In some examples, the casino device 300 includes a gaming device (e.g., an EGM such as EGM 100 or a device associated with a table game). In additional or alternative examples, the casino device 300 includes a device associated with a non-gaming activity (e.g., a point of sale terminal associated with a restaurant or hotel).

In additional or alternative embodiments, the casino device 300 validates the redemption code 382. In some examples, the casino device 300 validates the redemption code 382 by transmitting an indication of the redemption code 382 to the promotion management system 350. The promotion management system 350 can include a gaming system (e.g., gaming system 10 of FIG. 1) and/or a central controller (e.g., central controller 40 of FIG. 1). In additional or alternative embodiments, the casino device 300 notifies the user 310 that redemption of the redemption code 382 will make the non-gaming purchase final (e.g., prevent a return or refund of the non-gaming purchase).

In additional or alternative embodiments, in response to the redemption code 382 being valid (and the user 310 accepting that the non-gaming purchase will be made final), the casino device 300 can provide an award to the user 310. In some examples, the award is a gaming credit (e.g., free play or free spin). In additional or alternative examples, the award is a non-gaming credit (e.g., a discount or a subsequent non-gaming purchase). In additional or alternative examples, the award is a conditional credit (e.g., a reimbursement of a portion of the non-gaming purchase) that requires a condition be met. The condition can include a requirement that someone with the redemption code 382 play a predetermined amount of a wagering game within a predetermined amount of time of the non-gaming purchase or use of a product/service acquired by the non-gaming purchase. For example, the non-gaming purchase can include a ticket to a casino show and the conditional credit can include a reimbursement of a portion of a price of the ticket based on gameplay on an EGM with a period of time after the ticket is used to see the casino show.

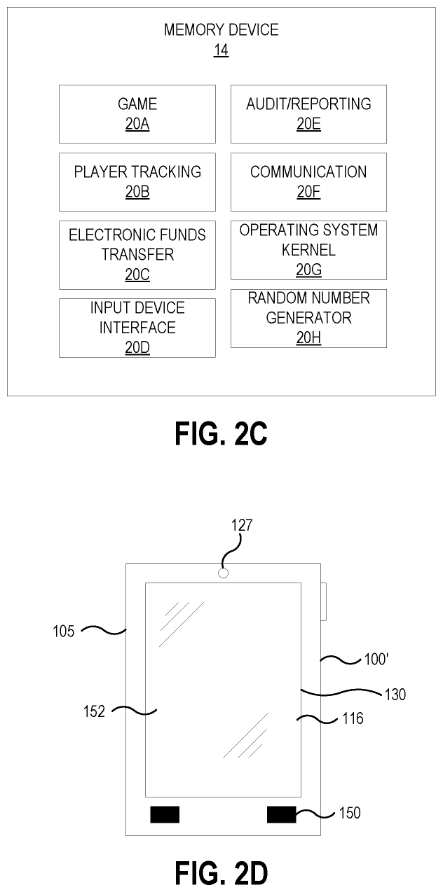

FIG. 4 illustrates another example of a network 400 that includes a casino device 300, promotion management system 350, and point of sale system 380. In contrast to the network 300 of FIG. 3, the network 400 of FIG. 4 is configured to allow the promotion management system 350 to provide the redemption code 382 to the user 310.

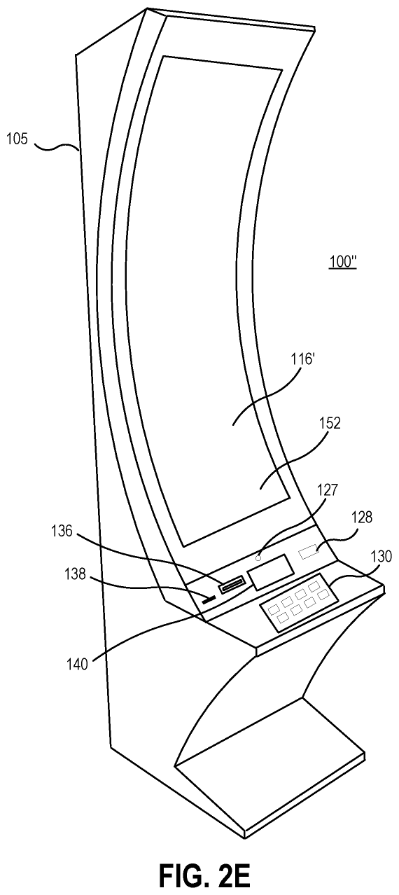

FIG. 5 illustrates another example of a network 500 that includes a casino device 300, promotion management system 350, and point of sale system 380. In contrast to the network 300 of FIG. 3 and the network 400 of FIG. 4, the network 500 further includes a non-gaming provider 590. The non-gaming provider 590 can be a device or system separate from the point of sale system 380 that provides a non-gaming product or service associated with the non-gaming purchase 312. Furthermore, the non-gaming provider 590 can provide the redemption code 382 to the user 310. For example, the non-gaming purchase 312 can include a ticket for a casino show and the non-gaming provider 590 can be associated with the theatre that provides the casino show. Once the ticket is scanned, the non-gaming provider 590 may provide the user 310 with the redemption code 382. In some examples, the redemption code 382 is generated by the non-gaming provider 590 and an indication of the redemption code 382 is transmitted by the non-gaming provider 590 to the promotion management system 350. In additional or alternative examples, the redemption code 382 is generated by the promotion management system 350 and an indication of the redemption code 382 is transmitted by the promotion management system 350 to the non-gaming provider 590.

Embodiments associated with providing a promotional award (also referred to herein as a credit) in response to a non-gaming purchase are described below.

In some embodiments, a configurable number of promotional credits can be awarded to a player via a code printed on a receipt from a retail and/or service spend location. In additional or alternative embodiments, a promotional voucher can be issued and printed at the retail location along with or as part of the receipt itself. A host system can allow for promotional funds to be configured as a fixed amount, or as a percentage of the purchase made at that point-of-sale location. An operator of the host system can define the parameters of the bonus and which retail/service spend locations are eligible. Once the receipt is printed, it can then be used on the casino floor via one or more of the delivery methods described below. In some examples, the codes can be printed as a QR code, a barcode, or a text-based code.

A description of embodiments associated with awarding a promotion (e.g., an award or a credit) to a player is described below. There are multiple ways in which the promotion can be provided to the player. In some examples, promotion codes may be configured with a limited number of redemptions. In additional or alternative examples, a delivery procedure includes a process for incrementing promotion redemptions.

In some embodiments, a redemption code (e.g., an identifier of the promotion and/or an identifier of a corresponding non-gaming purchase) can be manually entered in a service window. In some examples, manual entry of the redemption code supports anonymous player validation of promotion codes. A customer that receives the receipt will have a code they can manually enter into the service window to award them the promotional item. The service window can include a code entry screen, the customer (or an associated player) can enter the code into the service window, and a device associated with the service window can send the code to a host system for validation. The validation can check the code against registered promotion codes. Promotion codes may be configured with a limit on the number of times the promotion may be validated. In these examples, the host system can increment the validation count to ensure the promotion is not over-redeemed.

In additional or alternative embodiments, an anonymous player can insert a receipt (corresponding to the non-gaming purchase) into a receipt reader (e.g., a bill validator). In some examples, a customer that receives the receipt will insert the receipt into the bill validator of the EGM and the bar code on the receipt will scan to add credits to the credit meter of the game. In additional or alternative examples, the receipt itself can have an actual promotion voucher printed with the script that can be torn off and used at the EGM.

In additional or alternative embodiments, an anonymous player can use a camera to scan a gaming machine code. In some examples, the receipt will have a QR code or barcode that can be scanned by a player facing camera on a gaming machine. Once scanned an application protocol interface (“API”) in the gaming machine interprets the code and requests funds be transfer to the machine from a promotion management system if a matching code is found that is associated to the prize value. The credits are added to the credit meter and/or free play in the EGM based bonus pool bucket on the EGM itself, or even a handpay.

In additional or alternative embodiments, a player can scan a redemption code with a mobile device. In some examples, the customer receives a receipt with a QR code. The player scans the code with their mobile device, which will load a web-page that starts the redemption process. The hosted web-page can check if the promotion code is valid and that the redemption count has not been exceeded. The web page can further direct the player to interact with the game they would like to redeem their code on. The player can interact with the game service window to ‘Redeem a Promotion Code’. The game can display a unique code to identify the game. This code can be a random sequence of alpha-numeric characters that is generated by the promotion management system. The code may be unique, and may be temporary or designed for a single use. The player then enters this unique code into their mobile device, which is submitted to the promotion management system and the promotion redemption is validated and then sent to the game for player consumption. In additional or alternative embodiments, the player scans the code with their mobile device, and the promotion management system will generate a temporary code that the player can use to enter into the game. In some examples, the promotion management system can interact with the player to gather additional data (e.g., demographic data) from the player as part of the redemption process. In additional or alternative examples, the promotion management system can ask a player to create an account.

In additional or alternative embodiments, in response to a customer's non-gaming purchase a promotion management system can deliver a corresponding award to an account associated with the customer. In some examples, the player will associate their purchase at the retail point of sale (“POS”) with their account by scanning/swiping their player's club card (or tapping their mobile device using cardless connect). Players today are incentivized to associate their casino retail purchases with their account because they can earn points and other casino incentives for such purchases. In addition or alternatively to the code being printed on a receipt printed and given to the player, the code can be associated with the account of the player (the account the player has in the casino players club, the player's Resort Wallet account, or a separate retail awards account associated with the player's loyalty account).

In additional or alternative embodiments, the redemption code can be read by a mobile device via SMIB code redemption. In some examples, the customer receives a receipt with a QR code. The player scans the QR code with their mobile device, the QR code will direct the player to a hosted webpage that will check if the promotion code is valid, and that the redemption count has not been exceeded. The web page will then direct the player to interact with the game they would like to redeem their code on. The player interacts with the Game by carding into the game with the mobile device (typically using an operator's mobile app that supports Cardless Connect or similar technology). The mobile app can then pass the scanned QR code data to the SMIB inside the EGM which interacts with an application on the back-end of the system, and that application, upon successful redemption of the code, can send any award to the player at the EGM or directly to the player's account.

In additional or alternative embodiments, the redemption code can be redeemed by a mobile device via application host code redemption. In some examples, the customer receives a receipt with a QR code. The player scans the QR code with their mobile device, and that QR code launches the mobile app of the casino that's loaded on the player's mobile device. The mobile app then interacts with the application host directly to pass the scanned QR code data to the back-end of the system, and that application host, upon successful redemption of the code, can send any award to the player at the EGM or directly to the player's account.

Embodiments associated with how promotions (awards/credits) are provided are described below. There are multiple options for redemption of promotions in this system. In some embodiments, the promotion includes creation of a player club account via a mobile device from a receipt code. In some examples, the customer that receives the receipt will have a code they can scan with the camera on their mobile device that will take them to a player enrollment page for the casino club. Upon enrolling into the club, they are issued some amount of configurable sign-up promotional credits to their account.

In additional or alternative embodiments, the promotion procedure includes creation of a player club account via a kiosk using the receipt code. In some examples, the customer that receives the receipt will have a code they can scan with via a camera on Kiosk Terminal or insert into the terminal during the sign-up process for a player account. Upon enrolling into the club, they are issued some amount of configurable sign-up promotional credits to their account.

In additional or alternative embodiments, the promotion procedure includes an existing player club account being awarded via a mobile device from a receipt code. In some examples, the customer already has a players club account, and the player can scan or manually input the code from the receipt, which will take them to a web page or mobile app, where they log into their account and the configurable promotional credits are awarded to the player's account.

In additional or alternative embodiments, the promotion procedure includes an exiting player club account being awarded via a kiosk from a receipt code. In some examples, the customer that receives the receipt will have a code they can scan via a camera on a Kiosk or insert the receipt into the terminal that is logged into by the player using a credential for their players club account (e.g., physical players club card, Cardless Connect). After scanning the code on the receipt, they are issued some amount of configurable promotional credits to their account.

In additional or alternative embodiments, the promotion procedure includes a dealer of a table game scanning a code from a receipt and issuing chips to a player. In some examples, the customer that receives the receipt will have a code that a dealer or pit boss can then scan with a scanner to cash the code for chips to be used at the tables.

In additional or alternative embodiments, the promotion procedure includes a receipt code being used as a promotional drawing entry. In some examples, the customer that receives the receipt will have a code that can be entered into a service window to enter a virtual drawing for a prize that is presented on the Service Window and awarded to the player (if they win). Additionally, this could be scanned for entry into a physical prize drawing in the casino. In one embodiment, the award can be determined immediately. That is, after the player has entered the code into the Service Window. Alternatively, the award could be determined later on, or asynchronously from entering the code into the Service Window. Upon determination that the player won, they could be notified via the Service Window if they currently have an active session at an EGM. Alternatively, if the player doesn't have an active session at an EGM (or in addition to), the player could be notified of their award via a push notification to a mobile app of the player's mobile device, an SMS/Text message, an e-mail, or other suitable mechanism. If the player is at the EGM, a player balance available at the EGM could be adjusted to reflect the award (Xtra Credit, Points, Cashless Wagering Account, EGM Credit Meter, etc). If the player is not at the EGM, then a back-end account of the player should be adjusted to reflect the award (ex: Xtra Credit, Points, Cashless Wagering Account).

In additional or alternative embodiments, the promotion procedure includes a receipt code being used as a slot tournament walk up entry code. In some examples, the customer that receives the receipt will have a code that can be entered into the Service Window of a tournament bank of EGMs that is configured to be in “walk up entry mode”, whereby the EGMs display an entry screen on the Service Window to participate into the slot tournament.

In additional or alternative embodiments, the promotion procedure includes redemption of a receipt code associated with the player's loyalty account. In this example, the player goes to an EGM and can view the coupons that are available for redemption. They may select an option to redeem all eligible codes, or they may select an individual code to redeem. Upon redemption, the player's balances (either at the EGM or on the host) are immediately updated. If the code provides an entry into a drawing, then the award may not be determined immediately, and the player could be notified later that they won using one or more of the methods mentioned previously.

In additional or alternative embodiments, promotions may have multiple parameters. In some examples, each promotional code may have a limit on the number of times they can be redeemed (either by a single player or across all players or some group of players). In additional or alternative examples, each promotional code may have an eligible date range. In additional or alternative examples, each promotional code may have an eligibility criteria—the player must also perform action X, or Y, for the code to be eligible for redemption. For example, the player must also play $100 of coin in the day they attempt to redeem the code, or the player must sign up for a players club account, or sign up for a cashless wagering account.

In additional or alternative embodiments, the code itself can have different types of awards. In some examples, the type of the award can include an amount of player's club points. In additional or alternative examples, the type of the award can include an amount of promotional credits. In additional or alternative examples, the type of the award can include an amount of cashable credits to be deposited into the player's cashless wagering account. In additional or alternative examples, the type of the award can include a comp. In additional or alternative examples, the type of the award can include an entry into a tournament. In additional or alternative examples, the type of the award can include a physical item, such as a free night in a hotel room, concert tickets, a hat, or a t-shirt.

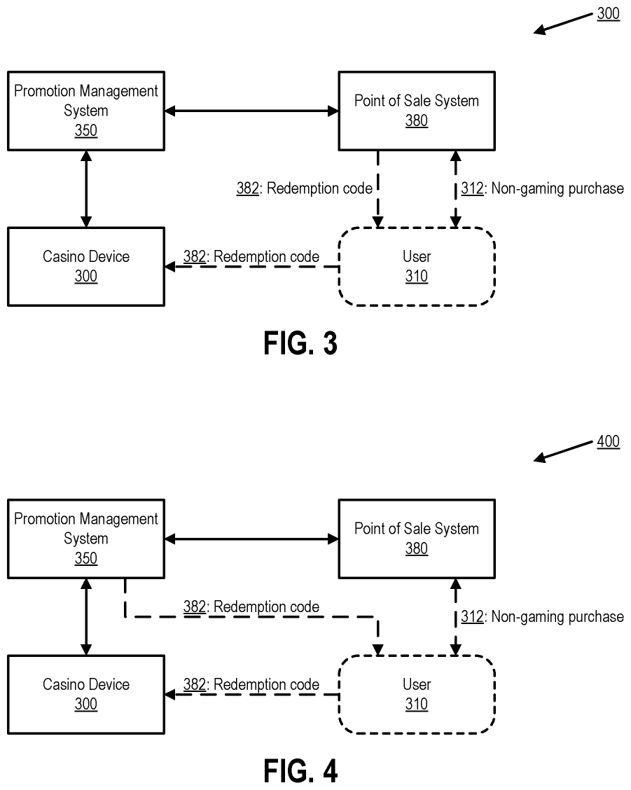

FIG. 6 illustrates examples of operations performed by an EGM according to some embodiments. Although the operations will be described in regards to processing circuit 12 and primary display 116 of EGM 100 of FIG. 2B, the operations can be performed by other elements of EGM 100 and/or by any suitable casino device (e.g., casino device 300).

At block 610, processing circuit 12 receives a redemption code associated with a previous non-gaming purchase.

At block 620, processing circuit 12 validates the redemption code. In some embodiments, validating the redemption code (also referred to herein as verifying the non-gaming purchase) can include transmitting an indication of the redemption code (or another identifier of the non-gaming purchase) to a promotion management system and receiving instructions from the promotion management system to provide an award associated with the redemption code.

At block 630, processing circuit 12 receives information associated with an award associated with the redemption code from a promotion management system. In some embodiments, the award is a gaming award (e.g., a number of free spins) to be provided by the EGM. In additional or alternative embodiments, the information associated with the award can include an amount of the award. In additional or alternative embodiments, the information associated with the award includes an indication of any terms or conditions placed on redeeming the redemption code for the award.

At block 640, processing circuit 12 outputs an indication that the previous purchase will be made final if the redemption code is redeemed. In some examples, the EGM can output the indication by visually displaying, audibly alerting, or digitally transmitting the indication to the user.

At block 650, processing circuit 12 receives an acceptance of the previous purchase being made final. In some examples, the EGM can receive an indication of the acceptance via any suitable input device (e.g., a touch screen, a microphone, a camera, or by receiving a message from a device associated with the user).

At block 660, processing circuit 12 provides the award associated with the redemption code. In some embodiments, the EGM provides the award within a wagering game being provided by the EGM. In additional or alternative embodiments, the EGM physically or digitally provides the user with the award.

At block 670, processing circuit 12 transmits an indication that the redemption code has been redeemed to the promotion management system. In some embodiments, the EGM notifies the promotion management system to ensure that the non-gaming purchase is made final and prevent the user from returning the non-gaming purchase after redeeming the award. In additional or alternative embodiments, the redemption code is only valid for a predetermined number of uses and the EGM notifies the promotion management system to ensure a counter associated with the number of uses of the redemption code is adjusted.

Various operations from the flow chart of FIG. 6 may be optional with respect to some embodiments of EGMs and related methods.

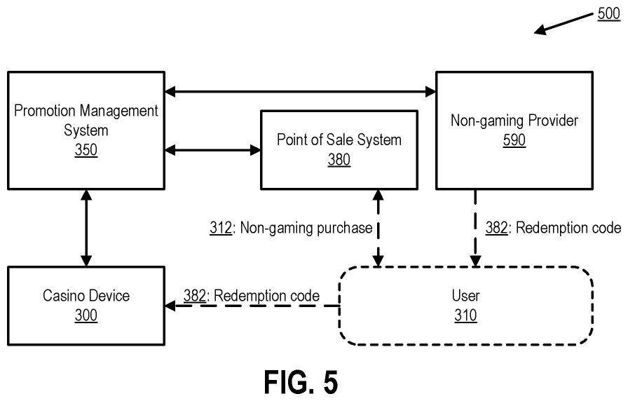

FIG. 7 illustrates examples of operations performed by a promotion management system according to some embodiments. Although the operations will be described in regards to processing circuit 40 of gaming system 10 of FIG. 1, the operations can be performed by any suitable promotion management system (e.g., promotion management system 350 of FIGS. 3-5).

At block 710, processing circuit 40 provides a redemption code associated with the non-gaming purchase to a user. In some embodiments, the promotion management system determines the redemption code and provides the redemption code to the user via a point of sale system. For example, the promotion management system provides an indication of the redemption code and an indication of a type of non-gaming purchase to the point of sale system along with instructions to provide the redemption code to a user making the type of non-gaming purchase from the point of sale system.

In additional or alternative embodiments, the promotion management system determines the redemption code and provides the redemption code directly to the user (and/or a device associated with the user). In additional or alternative embodiments, the promotion management system provides the redemption code to the user by transmitting authorization to a point of sale system to generate and provide the redemption code to the user.

In additional or alternative embodiments, the promotion management system stores an indication of the redemption code as associated with an award and/or a specific non-gaming purchase. In additional or alternative embodiments, the promotion management system determines an amount of the award based on a type or amount of the non-gaming purchase.

At block 720, processing circuit 40 receives the redemption code from a casino device.

At block 730, processing circuit 40 validates the redemption code. In some embodiments, validating the redemption code includes verifying that the non-gaming purchase was made and has not been cancelled or returned. In additional or alternative embodiments, validating the redemption code includes verifying that the redemption code and/or award associated with the non-gaming purchase has been used less than a threshold number of times.

At block 740, processing circuit 40 transmits an indication that the redemption code is valid to the casino device. In some embodiments, the casino device is a gaming device (e.g., an EGM or a device associate with a table game). In additional or alternative embodiments, the casino device is a non-gaming device (e.g., a device associated with a casino restaurant, a casino retail store, a casino hotel system, or a casino theatre).

At block 750, processing circuit 40 transmits information associated with an award associated with the redemption code to the casino device. In some embodiments, the casino device includes an EGM and the award includes a gaming-related award. In some examples, the EGM is configured to provide a slot game and the gaming-related award includes a number of free spins.

In additional or alternative embodiments, the non-gaming purchase is associated with a casino environment. The casino device is associated with a service in the casino environment and the award is associated with the service. In some examples, the casino device is associated with a hotel reservation system and the award is associated with a discount or upgrade to a room in the hotel. In additional or alternative examples, the casino device is associated with a restaurant in the casino and the ward is associated with a discount or guaranteed reservation at the restaurant.

In additional or alternative embodiments, transmitting the information associated with the award includes transmitting an indication that the award is only available for a certain period of time.

At block 760, processing circuit 40 receives an indication that the redemption code has been redeemed from the casino device. In some embodiments, the promotion management system adjusts whether the redemption code remains valid based on a number of times the redemption code has been used. The promotion management system further transmits the indication that the redemption code has been redeemed to a device associated with the non-gaming purchase (e.g., to ensure the non-gaming purchase is made final).

At block 770, processing circuit 40 stores an indication that the redemption code has been used. In some embodiments, the indication can indicate whether the redemption code remains valid. In additional or alternative embodiments, storing the indication can include deleting the redemption code from a set of valid redemption codes.

Various operations from the flow chart of FIG. 7 may be optional with respect to some embodiments of EGMs and related methods.

Embodiments associated with a promotional award that includes providing a credit to an account used to make a non-gaming purchase in response to completing a condition are described below. Similar to some embodiments above, providing the credit to the account used to make the non-gaming purchase can incentivize a casino patron to perform more activities within the casino environment.

In some embodiments, a user receives a redemption code in response to making a non-gaming purchase and/or using a product or service associated with the non-gaming purchase. The redemption code can be provided to a casino device that monitors activity by the user and provides an indication of the activity to a promotion management system. The promotion management system can determine when a condition associated with the redemption code is met and in response to the condition being met, credit an account that made the non-gaming purchase.

In additional or alternative embodiments, the condition is predetermined and indicated to a purchaser prior to purchase of the non-gaming purchase. In other embodiments, the condition is not revealed (or even generated) until the redemption code has been provided to a casino device. In additional or alternative embodiments, a type of the condition is based on the type of casino device to which the redemption code is provided.

In additional or alternative embodiments, providing the credit can serve as an anti-scalping mechanism by only crediting an account associated with the original purchaser. In some examples, a ticket to a casino show can be set much higher than usual with an ability to receive a significant credit back to the account by using a corresponding redemption code during use of an EGM within an hour after the end of the show corresponding to the ticket. Although the condition for receiving the credit back to the account may be simple, the redemption code may only be provided to the user of the ticket who will be unlikely to use the redemption code if they were not the original buyer of the ticket. Therefore, the “fair market value” of a ticket may be seen as the price after receiving the credit to the account, but scalpers will be unable to sell the ticket for less than the amount they originally bought the ticket for (which may be much higher than the “fair market value).

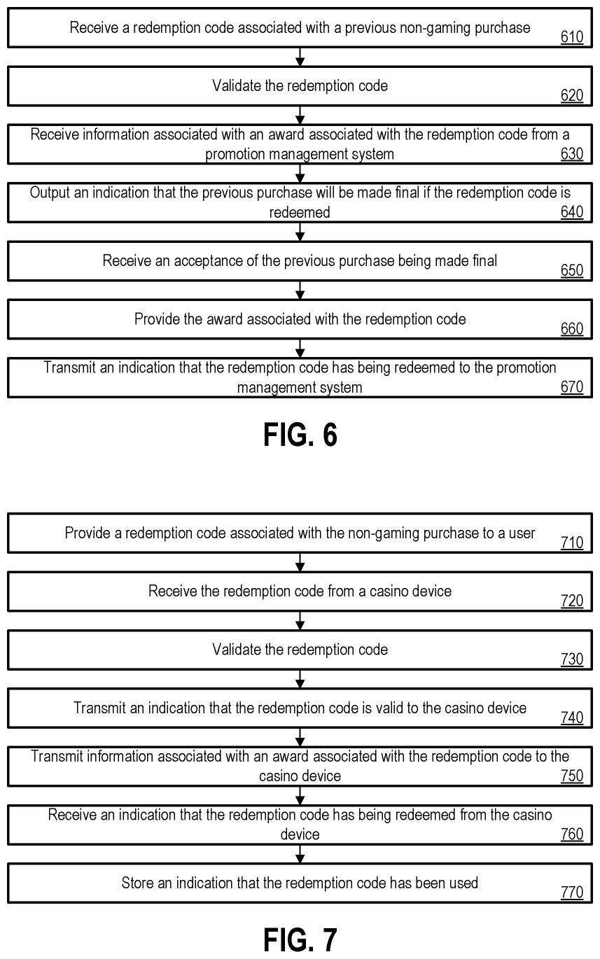

FIG. 8 illustrates examples of operations performed by an EGM according to some embodiments. Although the operations will be described in regards to processing circuit 12 and primary display 116 of EGM 100 of FIG. 2B, the operations can be performed by other elements of EGM 100 and/or by any suitable casino device (e.g., casino device 300).

Similar to FIG. 6, at block 610, processing circuit 12 receives a redemption code associated with a previous non-gaming purchase and at block 620, processing circuit 12 validates the redemption code.

At block 830, processing circuit 12 receives information associated with a condition associated with the redemption code from a promotion management system. In some embodiments, the condition includes a predetermined amount of gameplay (e.g., an amount wagered or a number of wagering games played) within a predetermined amount of time of the non-gaming purchase or an event associated with the non-gaming purchase (e.g., use of a product or service acquired by the non-gaming purchase).

At block 840, processing circuit 12 outputs an indication of the condition. At block 850, processing circuit 12 determines that the condition has been met. In some embodiments, determining that the condition has been met includes receiving user acknowledgement that the non-gaming purchase will be made final and that a credit will be applied to an account associated with an individual that made the non-gaming purchase.

At block 860, processing circuit 12 transmits an indication that the condition has been met to the promotion management system.

Various operations from the flow chart of FIG. 8 may be optional with respect to some embodiments of EGMs and related methods.

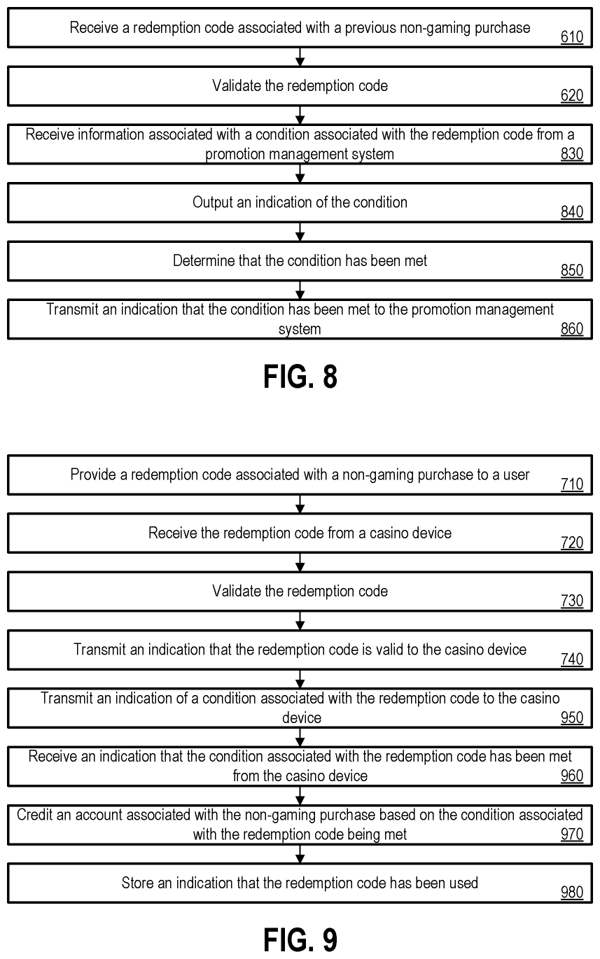

FIG. 9 illustrates examples of operations performed by a promotion management system according to some embodiments. Although the operations will be described in regards to processing circuit 40 of gaming system 10 of FIG. 1, the operations can be performed by any suitable promotion management system (e.g., promotion management system 350 of FIGS. 3-5).

Similar to FIG. 7: 1) At block 710, processing circuit 40 provides a redemption code associated with the non-gaming purchase to a user; 2) At block 720, processing circuit 40 receives the redemption code from a casino device; 3) At block 730, processing circuit 40 validates the redemption code; and 4) At block 740, processing circuit 40 transmits an indication that the redemption code is valid to the casino device.

At block 950, processing circuit 40 transmits an indication of a condition associated with the redemption code to the casino device. In some embodiments, the casino device is a gaming device. In some examples, the condition includes a predetermined amount of gameplay (e.g., an amount wagered or a number of wagering games played) within a predetermined amount of time of the non-gaming purchase or an event associated with the non-gaming purchase (e.g., use of a product or service acquired by the non-gaming purchase). In additional or alternative embodiments, the casino device is a non-gaming device. In some examples, the condition includes an amount of non-gaming spend or non-gaming time spent performing a non-gaming activity within the casino environment.

In additional or alternative embodiments, the promotion management system determines the condition associated with the redemption code based on characteristics of the non-gaming purchase, the user, and/or the casino device.

At block 960, processing circuit 40 receives an indication that the condition associated with the redemption code has been met from the casino device. In some embodiments, receiving the indication includes receiving a message explicitly indicating that the condition has been met. In additional or alternative embodiments, receiving the indication includes receiving an indication of an amount of time or money spent by the user and determining that the amount of time or money spent is above a threshold associated with the condition.

At block 970, processing circuit 40 credits an account associated with the non-gaming purchase based on the condition associated with the redemption code being met. In some embodiments, the promotion management system credits the account by transmitting a request to credit the account to a point of sale system that sold the non-gaming purchase. In additional or alternative embodiments, the non-gaming purchase is made via a casino wallet or casino account and the promotion management system applies the credit directly to the casino wallet or casino account.

At block 980, processing circuit 40 stores an indication that the redemption code has been used. In some embodiments, the promotion management system adjusts whether the redemption code remains valid based on a number of times the redemption code has been used. The promotion management system further transmits the indication that the redemption code has been redeemed to a device associated with the non-gaming purchase (e.g., to ensure the non-gaming purchase is made final). In additional or alternative embodiments, the indication can indicate whether the redemption code remains valid. In additional or alternative embodiments, storing the indication can include deleting the redemption code from a set of valid redemption codes.

Various operations from the flow chart of FIG. 9 may be optional with respect to some embodiments of EGMs and related methods.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A system comprising:
processing circuitry; and
memory coupled to the processing circuitry and having instructions stored therein that are executable by the processing circuitry to cause the system to perform operations including:
determining that an individual made a non-gaming purchase;
determining that a gaming-related condition has been met subsequent to the non-gaming purchase, the gaming-related condition being associated with play of a wagering game; and
applying a credit to an account associated with the individual based on determining that the gaming-related condition has been met.

2. The system of claim 1, wherein determining that the gaming-related condition has been met includes receiving an indication from an electronic gaming machine (“EGM”) that the gaming-related condition has been met.

3. The system of claim 2, wherein determining that the individual made the non-gaming purchase includes determining an identifier of the non-gaming purchase, and
wherein determining that the gaming-related condition has been met includes receiving the identifier of the non-gaming purchase from the EGM.

4. The system of claim 2, wherein determining that the individual made the non-gaming purchase includes determining an identifier of the individual, and
wherein determining that the gaming-related condition has been met includes receiving an identifier of the individual from the EGM.

5. The system of claim 1, wherein the gaming-related condition includes a user playing the wagering game within a window of time, and
wherein determining that the gaming-related condition has been met includes:
receiving an indication of a time that the user played the wagering game; and
determining that the gaming-related condition has been met based on the time that the user played the wagering game being within the window of time.

6. The system of claim 5, wherein determining that the individual made the non-gaming purchase includes determining a time that the individual made the non-gaming purchase, and
wherein determining that the gaming-related condition has been met includes determining the window of time based on the time that the individual made the non-gaming purchase.

7. The system of claim 5, wherein the non-gaming purchase includes a purchase of a future product or future service, and
wherein determining that the gaming-related condition has been met includes:
receiving an indication of a time that the future product or future service was provided; and
determining the window of time based on the time that the future product or future service was provided.

8. The system of claim 7, wherein the non-gaming purchase includes a purchase of a ticket for a casino show, and
wherein the future service includes the casino show.

9. The system of claim 1, wherein determining that an individual made a non-gaming purchase includes applying a debit to the account associated with the individual, and
wherein applying the credit to the account includes reducing the debit being applied to the account association with the individual.

10. The system of claim 9, wherein the account associated with the individual includes a virtual wallet provided by a casino associated with the system.

11. The system of claim 1, wherein determining that the individual made the non-gaming purchase includes subsequent to determining that the gaming-related condition has been met, determining that the non-gaming purchase is valid, and
wherein applying the credit to the account associated with the individual includes applying the credit to the account based on determining that the non-gaming purchase is valid.

12. The system of claim 1, wherein determining that the individual made the non-gaming purchase includes prior to applying the credit to the account, determining that less than a threshold number of credits have been applied to the account in association with the non-gaming purchase, and
wherein crediting the account associated with the individual includes crediting the account based on determining that less than the threshold number of credits have been applied to the account in association with the non-gaming purchase.

13. The system of claim 1, the operations further including:
transmitting an indication that the non-gaming purchase is final.

14. The system of claim 1, the operations further including:
providing an offer to the individual indicating the non-gaming purchase, the gaming-related condition, and the credit.

15. The system of claim 1, the operations further including:
determining an amount of the credit based on the non-gaming purchase.

16. The system of claim 1, the operations further including:
determining an amount of the credit based on a gaming-related action performed to meet the gaming-related condition.

17. An electronic gaming machine (“EGM”) comprising:
processing circuitry; and
memory coupled to the processing circuitry and having instructions stored therein that are executable by the processing circuitry to cause the EGM to perform operations including:
receiving user input indicating an identifier of a non-gaming purchase;
transmitting an indication of the identifier of the non-gaming purchase to a remote device;
responsive to transmitting the indication of the identifier of the non-gaming purchase, receiving an indication of a gaming-related condition;
determining that the gaming-related condition has been met; and
transmitting an indication that the gaming-related condition has been met.

18. The EGM of claim 17, wherein receiving the user input indicating the identifier of the non-gaming purchase includes scanning a code on a receipt of the non-gaming purchase.

19. The EGM of claim 17, the operations further including:
responsive to determining that the gaming-related condition has been met, receiving user input acknowledging that the non-gaming purchase will be made final and requesting that a credit be applied to an account associated with an individual that made the non-gaming purchase.

20. A non-transitory computer readable medium having instructions stored therein that are executable by processing circuitry to cause the processing circuitry to perform operations comprising:
determining that a gaming-related condition has been met subsequent to a non-gaming purchase; and
applying a credit to an account used to make the non-gaming purchase based on determining that the gaming-related condition has been met.
